(19) United States
(12) Patent Application Publication
(10) Pub. No.: US 2026/0343322 A1
(43) Pub. Date: Oct. 29, 2026

(54) METHOD AND DEVICE FOR MANAGING BUFFER OR REAL-TIME ULTRA-LOW LATENCY TRAFFIC IN WIRELESS COMMUNICATION SYSTEM

(71) Applicant: Samsung Electronics Co., Ltd., Gyeonggi-do (KR)

(72) Inventors: Sunhyun KIM, Gyeonggi-do (KR); Sangho LEE, Gyeonggi-do (KR); Jiyoung CHA, Gyeonggi-do (KR); Dongmyung KIM, Gyeonggi-do (KR); Jinho CHOI, Gyeonggi-do (KR)

(21) Appl. No.: 19/123,310

(22) PCT Filed: Jan. 3, 2024
(86) PCT No.: PCT/KR2024/000112

§ 371 Date: Apr. 22, 2025

(30) Foreign Application Priority Data
Jan. 3, 2023 (KR) 10-2023-0000867

(51) Int. Cl. H04W 28/14; H04W 28/06; H04W 76/27

(52) U.S. Cl. CPC H04W 28/14; H04W 28/06; H04W 76/27

(57) ABSTRACT

The present disclosure relates to a 5G or 6G communication system for supporting higher data transmission rates than 4G communication systems such as LTE. A method performed in a wireless communication system by a transmission device for an ultra-low latency service according to the present invention may comprise the steps of: receiving I-frame-related packets with sequence numbers different from a sequence of packets stored in a buffer; confirming the number of effective packets on the basis of frame per second (FPS) values; and deleting the packets stored in the buffer except for a number of packets equivalent to the number of effective packets.

### TECHNICAL FIELD

The disclosure relates to a technology for supporting ultra-low latency real-time streaming services in a communication system. The communication system may include both existing mobile communication networks such as 3G/LTE/5G and B5G/6G that are expected to be applied in the future. Ultra-low latency real-time streaming services may include currently supported real-time streaming and VR/AR/XR and holograms, which are expected to be applied in the future.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE

### Technical Problem

The disclosure provides a method that efficiently manages packets failing to satisfy realtimeness in an ultra-real-time streaming service when the wireless environment temporarily deteriorates.

According to various embodiments of the disclosure, unnecessary transmission of packets that are not valid in realtimeness may be avoided to prevent waste of wireless resources and time, buffering delay time that may occur during video playback may be avoided, and the transmitting side and receiving side may be made aware of intentional avoidance of unnecessary transmission.

### Technical Solution

To solve the above problems, the disclosure provides a method performed by a transmitting device for an ultra-low latency service in a communication system. The method may include: receiving an I-frame related packet having a sequence number different from a sequence of packets stored in a buffer; identifying a number of valid packets based on a frames-per-second (FPS) value; and deleting packets stored in the buffer except for packets corresponding to the number of valid packets.

In addition, to solve the above problems, the disclosure provides a method performed by a receiving device for an ultra-low latency service in a communication system. The method may include: receiving a packet from a transmitting device; identifying a packet deleted by the transmitting device based on packet deletion information included in the received packet; and processing the received packet without reordering for the deleted packet.

In addition, to solve the above problems, the disclosure provides a transmitting device for an ultra-low latency service in a communication system. The transmitting device may include: a transceiver; and a controller coupled with the transceiver, wherein the controller may be configured to: receive an I-frame related packet having a sequence number different from a sequence of packets stored in a buffer; identify a number of valid packets based on a frames-per-second (FPS) value; and delete packets stored in the buffer except for packets corresponding to the number of valid packets.

In addition, to solve the above problems, the disclosure provides a receiving device for an ultra-low latency service in a communication system. The receiving device may include: a transceiver; and a controller coupled with the transceiver, wherein the controller may be configured to: receive a packet from a transmitting device; identify a packet deleted by the transmitting device based on packet deletion information included in the received packet; and process the received packet without reordering for the deleted packet.

### Advantageous Effects

Through the embodiments of the disclosure, the transmitting device may transmit only packets containing frames valid in realtimeness to the receiving device. Through the embodiments of the disclosure, it is possible to increase the efficiency of radio resource usage by transmitting only data that can improve user service performance through not transmitting frames that are not valid in realtimeness, and to reduce service latency time by eliminating time consumed in unnecessary transmission.

### DESCRIPTION OF DRAWINGS

FIG. 1 is a diagram illustrating the architecture of an LTE system according to the disclosure.

FIG. 2 is a diagram showing the structure of radio protocols in the LTE system according to the disclosure.

FIG. 3 is a diagram illustrating the architecture of a next-generation mobile communication system according to the disclosure.

FIG. 4 is a diagram illustrating the structure of radio protocols in the next-generation mobile communication system according to the disclosure.

FIG. 5 is a diagram illustrating a problem when a single data radio bearer (DRB) is used according to the disclosure.

FIG. 6A is a diagram illustrating a method of using two DRBs to address delayed video playback according to the disclosure.

FIG. 6B is a diagram illustrating a method of using three DRBs to address delayed video playback according to the disclosure.

FIG. 7A illustrates an embodiment of managing packets in a single DRB for ultra-low latency service according to an embodiment of the disclosure.

FIG. 7B illustrates an embodiment of managing packets when dual DRBs are set for ultra-low latency service according to an embodiment of the disclosure.

FIG. 7C illustrates an embodiment of managing packets when triple DRBs are set for ultra-low latency service according to an embodiment of the disclosure.

FIG. 8A illustrates an embodiment of managing packets when a single DRB is set for ultra-low latency service according to an embodiment of the disclosure.

FIG. 8B illustrates an embodiment of managing packets when dual DRBs are set for ultra-low latency service according to an embodiment of the disclosure.

FIG. 8C illustrates an embodiment of managing packets when triple DRBs are set for ultra-low latency service according to an embodiment of the disclosure.

FIG. 9A illustrates an embodiment of managing packets when a single DRB is set for ultra-low latency service according to an embodiment of the disclosure.

FIG. 9B illustrates an embodiment of managing packets when dual DRBs are set for ultra-low latency service according to an embodiment of the disclosure.

FIG. 9C illustrates an embodiment of managing packets when triple DRBs are set for ultra-low latency service according to an embodiment of the disclosure.

FIG. 10 is a diagram illustrating a decodable frame group (DFG), which is a unit that can be decoded, according to an embodiment of the disclosure.

FIG. 11A is a diagram illustrating a method of managing packets based on the DFG according to an embodiment of the disclosure.

FIG. 11B is a diagram illustrating a method of managing packets based on the DFG when triple DRBs are set according to an embodiment of the disclosure.

FIG. 12 is a diagram illustrating a method for the transmitting device to inform the receiving device of packet drop related information according to an embodiment of the disclosure.

FIG. 13 is a diagram illustrating a header format according to an embodiment of the disclosure.

FIG. 14 is a diagram illustrating a flowchart of the receiving device in the case of packet drop according to an embodiment of the disclosure.

FIG. 15 illustrates a sequence diagram for configuring DRBs for ultra-real-time streaming service according to an embodiment of the disclosure.

FIG. 16 is a diagram illustrating the structure of a transmitting device according to an embodiment of the disclosure.

FIG. 17 is a diagram illustrating the structure of a receiving device according to an embodiment of the disclosure.

### MODE FOR DISCLOSURE

Hereinafter, embodiments of the disclosure will be described in detail with reference to the accompanying drawings.

In describing the embodiments, descriptions of technical contents that are well known in the technical field to which the disclosure belongs and are not directly related to the disclosure will be omitted. This is to convey the subject matter of the disclosure more clearly without obscuring it by omitting unnecessary explanations.

For the same reason, some components in the attached drawings are exaggerated, omitted, or schematically illustrated. Also, the size of each component does not necessarily reflect the actual size. In each drawing, identical or corresponding components are given the same reference symbols.

The advantages and features of the disclosure and the methods for achieving them will become clear when referring to the embodiments described below in detail along with the accompanying drawings. However, the disclosure is not limited to those embodiments disclosed below and may be implemented in various different forms, the embodiments are provided only to make the disclosure of the present disclosure complete and to fully inform a person having ordinary skill in the art to which the disclosure belongs of the scope of the disclosure, and the disclosure is defined only by the scope of the claims. Throughout the specification, the same reference numerals refer to the same components. Additionally, when explaining the disclosure, if it is considered that a specific description of a related function or configuration may unnecessarily obscure the gist of the disclosure, the detailed description will be omitted. Further, the terms described below are terms defined in consideration of the functions in this disclosure, and may vary depending on the intention or custom of the user or operator. Therefore, the definitions should be made based on the contents throughout this specification.

In describing the embodiments of the disclosure, the main target is New Radio (NR), which is a wireless access network, and the core network, packet core 5G System, or 5G core network, or NG core (next generation core), in the 5G mobile communication standards specified by 3GPP (3rd Generation Partnership Project) being a mobile communication standardization organization. However, the main gist of the disclosure may be applied to other communication systems having similar technical backgrounds with minor modifications not significantly departing from the scope of the disclosure. This will be possible at the discretion of a person having technical knowledge and skilled in the technical field of the disclosure.

For the convenience of description below, some terms and names defined in the 3GPP standards (standards for 5G, NR, LTE, or similar systems) may be used. However, the disclosure is not limited by such terms and names and may be equally applied to systems conforming to other standards.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

In the following description, the “base station (BS)”, as a main agent that allocates resources to a terminal, may be at least one of Node B, eNode B, gNode B, radio access unit, base station controller, or node on a network. The “terminal” may include a user equipment (UE), a mobile station (MS), a cellular phone, a smartphone, a computer, or a multimedia system capable of performing a communication function. In the disclosure, downlink (DL) refers to a wireless transmission path through which a base station transmits a signal to a terminal, and uplink (UL) refers to a wireless transmission path through which a terminal transmits a signal to a base station.

Meanwhile, it is known to those skilled in the art that blocks of a flowchart (or sequence diagram) and a combination of flowcharts may be executed by computer program instructions. These computer program instructions may be loaded on a processor of a general purpose computer, special purpose computer or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

In addition, a block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order according to their corresponding functions.

In the description, the word “unit”, “module” or the like may refer to a software component or hardware component such as an FPGA (field programmable gate array) or ASIC (application specific integrated circuit) capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose large components and units. Components and units may be configured to drive a device or one or more processors in a secure multimedia card. Also, in an embodiment, a unit or the like may include one or more processors.

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its position.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multiantenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

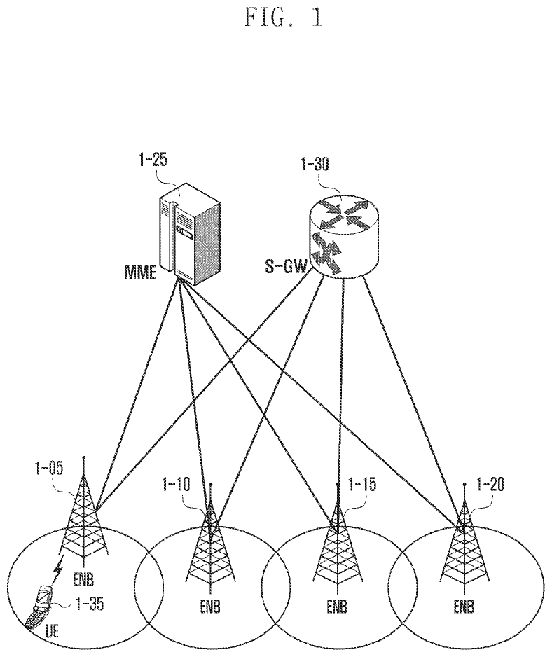

FIG. 1 is a diagram illustrating the architecture of an LTE system according to the disclosure.

With reference to FIG. 1, as illustrated, the radio access network of the LTE system may be composed of an LTE base station (evolved node B, hereinafter LTE eNB, eNB or base station) 1-05, 1-10, 1-15 or 1-20, a mobility management entity (MME) 1-25, and a serving-gateway (S-GW) 1-30. A user equipment (UE or terminal) 1-35 may connect to an external network through the eNB 11-05, 1-10, 1-15 or 1-20 and the S-GW 1-30.

In FIG. 1, the eNBs 1-05, 1-10, 1-15 or 1-20 correspond to Node Bs of the universal mobile telecommunication system (UMTS). The eNB 1-15 may be connected to the UE 1-35 through a radio channel, and may perform more complex functions in comparison to the Node B. In the LTE system, all user traffic including real-time services like VoIP (Voice over IP) may be served through shared channels. Hence, an apparatus is needed to perform scheduling on the basis of collected status information regarding buffers, available transmit powers and channels of the UEs, and the eNBs 1-05, 1-10, 1-15 or 1-20 can be responsible for this. One eNB may control multiple cells in a typical situation. To achieve a data rate of, for example, 100 Mbps in a bandwidth of, for example, 20 MHz, the LTE system may utilize orthogonal frequency division multiplexing (OFDM) as radio access technology. Also, the LTE system may apply adaptive modulation and coding (AMC) to determine the modulation scheme and channel coding rate according to channel states of the UE. The S-GW 1-30 is an entity providing data bearers, and may create and remove data bearers under the control of the MME 1-25. The MME 1-25 is an entity in charge of various control functions including a mobility management function for the UE, and may be connected to a plurality of eNBs.

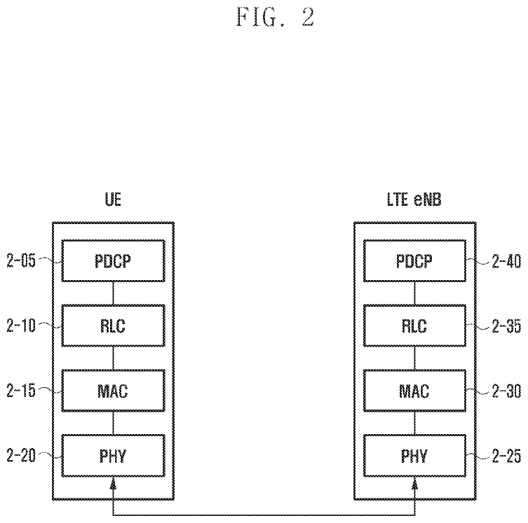

FIG. 2 is a diagram showing the structure of radio protocols in the LTE system according to the disclosure.

With reference to FIG. 2, in a UE or an eNB, the radio protocols of the LTE system may be composed of packet data convergence protocol (PDCP) 2-05 or 2-40, radio link control (RLC) 2-10 or 2-35, and medium access control (MAC) 2-15 or 2-30. The PDCP 2-05 or 2-40 may perform compression and decompression of IP headers. The PDCP may include one or more of the following functions.
Header compression and decompression function (header compression and decompression)
User data transfer function (transfer of user data)
In-sequence delivery function (in-sequence delivery of upper layer PDUs at PDCP re-establishment procedure for RLC AM)
Reordering function (for split bearers in DC (only support for RLC AM): PDCP PDU routing for transmission and PDCP PDU reordering for reception)
Duplicate detection function (duplicate detection of lower layer SDUs at PDCP re-establishment procedure for RLC AM)
Retransmission function (retransmission of PDCP SDUs at handover and, for split bearers in DC, of PDCP PDUs at PDCP data-recovery procedure, for RLC AM)
Cipher and decipher function (ciphering and deciphering)
Timer-based SDU discard function (timer-based SDU discard in uplink)

The RLC 2-10 or 2-35 may reconfigure PDCP PDUs (protocol data unit) to a suitable size and perform ARQ operation. The RLC may include one or more of the following functions.
Data transfer function (transfer of upper layer PDUs)
ARQ function (error correction through ARQ (only for AM data transfer))
Concatenation, segmentation and reassembly function (concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplicate detection function (duplicate detection (only for UM and AM data transfer))
Error detection function (protocol error detection (only for AM data transfer))
RLC SDU discard function (RLC SDU discard (only for UM and AM data transfer))
RLC re-establishment function (RLC re-establishment)

The MAC 2-15 or 2-30 may be connected with multiple RLC entities configured in a UE, and it may multiplex RLC PDUs into MAC PDUs and demultiplex MAC PDUs into RLC PDUs. The MAC may include one or more of the following functions.
Mapping function (mapping between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The physical layer (PHY) 2-20 or 2-25 may convert higher layer data into OFDM symbols by means of channel coding and modulation and transmits the OFDM symbols through a radio channel, or it may demodulate OFDM symbols received through a radio channel, perform channel decoding, and forward the result to a higher layer.

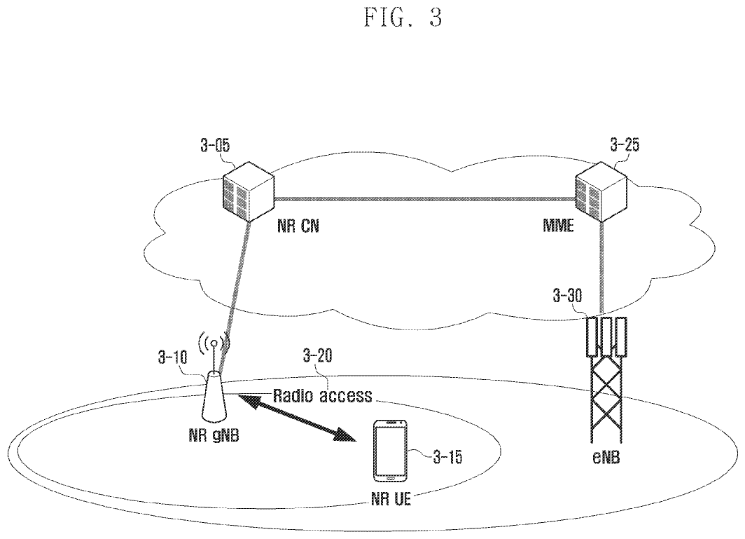

FIG. 3 is a diagram illustrating the architecture of a next-generation mobile communication system according to the disclosure.

With reference to FIG. 3, the radio access network of a next-generation mobile communication system (hereinafter. NR or 5G) may be composed of a new radio node B (NR gNB, gNB or base station) 3-10 and a new radio core network (NR CN) 3-05. Anew radio user equipment (NR UE or terminal) 3-15 may connect to an external network through the NR gNB 3-10 and the NR CN 3-05.

In FIG. 3, the NR gNB 3-10 may correspond to the eNB of the LTE system. The NR gNB may be connected to the NR UE 3-15 through a radio channel, and it can provide a more superior service than that of the eNB. All user traffic may be serviced through shared channels in the next-generation mobile communication system. Hence, there is a need for an entity that performs scheduling by collecting status information, such as buffer states, available transmission power states, and channel states of individual UEs, and the NR gNB 3-10 may take charge of this scheduling. One NR gNB may normally control a plurality of cells. To implement ultra-high-speed data transmission compared with LTE, a bandwidth beyond the maximum bandwidth of LTE may be utilized, and a beamforming technology may be additionally combined with orthogonal frequency division multiplexing (OFDM) serving as a radio access technology. Further, an adaptive modulation and coding (AMC) scheme determining a modulation scheme and channel coding rate to match the channel state of the UE may be applied. The NR CN 3-05 may perform functions such as mobility support, bearer configuration, and quality of service (QoS) configuration. The NR CN is an entity taking charge of not only mobility management but also various control functions for the UE, and may be connected to a plurality of base stations. In addition, the next-generation mobile communication system may interwork with the LTE system, and the NR CN 3-05 may be connected to the MME 3-25 through a network interface. The MME 3-25 may be connected to the eNB 3-30.

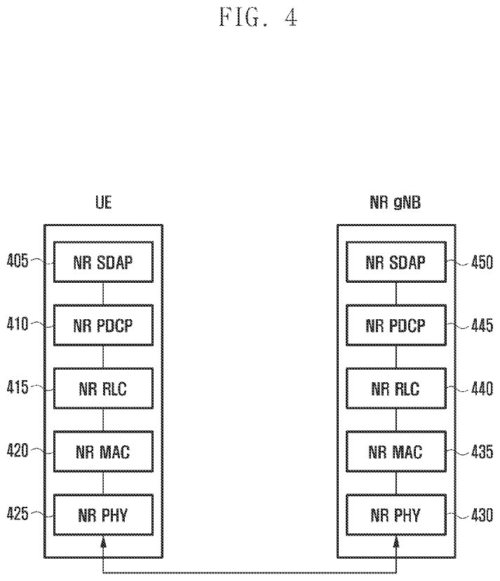

FIG. 4 is a diagram illustrating the structure of radio protocols in the next-generation mobile communication system according to the disclosure.

With reference to FIG. 4, in a UE or an NR gNB, the radio protocols of the next-generation mobile communication system may be composed of NR service data adaptation protocol (SDAP) 405 or 450, NR PDCP 410 or 445, NR RLC 415 or 440, and NR MAC 420 or 435.

The NR SDAP 405 or 450 may include one or more of the following functions.
User data transfer function (transfer of user plane data)
Mapping function between QoS flows and data bearers for uplink and downlink (mapping between a QoS flow and a DRB for both DL and UL)
QoS flow ID marking function for uplink and downlink (marking QoS flow ID in both DL packets and UL packets)
Mapping reflective QoS flow to data bearer for uplink SDAP PDUs (reflective QoS flow to DRB mapping for the UL SDAP PDUs)

With respect to the SDAP entity, the UE may be configured with, through a RRC message, whether to use a header of the SDAP entity or whether to use a function of the SDAP entity for each PDCP entity, bearer, or logical channel. If a SDAP header is configured, a NAS reflective QoS 1-bit indication and AS reflective QoS 1-bit indication of the SDAP header may be used to instruct the UE to update or reconfigure the mapping information between QoS flows and data bearers for the uplink and downlink. The SDAP header may include QoS flow ID information indicating the QoS. The QoS information may be used as data processing priority and scheduling information for supporting smooth services.

The NR PDCP 410 or 445 may include one or more of the following functions.
Header compression and decompression function (header compression and decompression: ROHC only)
User data transfer function (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Cipher and decipher function (ciphering and deciphering)
Timer-based SDU discard function (timer-based SDU discard in uplink)

In the above description, the reordering function of the NR PDCP entity may mean reordering of PDCP PDUs received from a lower layer in order based on the PDCP sequence number (SN), and it may include delivering data to an upper layer in reordered sequence, may include directly delivering data without considering the order, may include recording lost PDCP PDUs through reordering, may include reporting the status of lost PDCP PDUs to the transmitting side, or may include requesting retransmission of the lost PDCP PDUs.

The NR RLC 415 or 440 may include one or more of the following functions.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

In the above description, in-sequence delivery of the NR RLC entity may mean in-sequence delivery of RLC SDUs received from a lower layer to an upper layer. In-sequence delivery of the NR RLC entity may include reassembly and delivery of RLC SDUs when several RLC SDUs belonging to one original RLC SDU are received after segmentation, may include reordering of received RLC PDUs based on the RLC sequence number (SN) or the PDCP SN, may include recording lost RLC PDUs through reordering, may include reporting the status of the lost RLC PDUs to the transmitting side, may include requesting retransmission of the lost RLC PDUs, may include, if there is a lost RLC SDU, in-sequence delivery of only RLC SDUs before the lost RLC SDU to an upper layer, may include, although there is a lost RLC SDU if a specified timer has expired, in-sequence delivery of all the RLC SDUs received before the starting of the timer to an upper layer, or may include, although there is a lost RLC SDU if a specified timer has expired, in-sequence delivery of all the RLC SDUs received up to now to an upper layer. The NR RLC entity may process RLC PDUs in the order of reception (e.g., in order of arrival regardless of the order of the sequence number), and transfer them to the NR PDCP entity in an out-of-sequence delivery manner. Or, in the case of receiving a segment, the NR RLC entity may reconstruct one whole RLC PDU from segments stored in the buffer or received later, and transfer it to the NR PDCP entity. The NR RLC layer may not include a concatenation function, which may be performed by the NR MAC layer or may be replaced with a multiplexing function of the NR MAC layer.

Out-of-sequence delivery of the NR RLC entity may mean a function of transferring RLC SDUs received from a lower layer directly to a higher layer regardless of their order, and may include, if several RLC SDUs belonging to one original RLC SDU are received after segmentation, reassembly and delivery of the RLC SDUs, and may include storing the RLC SNs or PDCP SNs of received RLC PDUs and ordering them to record lost RLC PDUs.

The NR MAC 420 or 435 may be connected to several NR RLC entities configured in one UE, and the NR MAC may include one or more of the following functions.
Mapping function (mapping between logical channels and transport channels)
Multiplexing and demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The NR PHY 425 or 430 may compose OFDM symbols from higher layer data through channel coding and modulation and transmit them through a radio channel, or may demodulate and channel-decode OFDM symbols received through a radio channel and forward the result to a higher layer.

Meanwhile, the disclosure discloses a UE (smartphone, feature phone, smart glass, or the like), a base station, an RLC buffer, a data radio bearer (DRB), a packet (packet including I-frame, packet including P-frame, packet including B-frame). It also includes a technique for adding an ultra-real-time streaming-oriented DRB, encoding options for the codec, encoding option identification signaling, a technique for differentially applying buffers for encoding options, and RLC buffer management technique for ultra-real-time streaming-oriented DRB.

Next, terms used in the disclosure will be explained.

### [QoS, Quality of Service]

Mobile communication users receive various application services through the same mobile communication network. These various services have different requirements for themselves, and the core of QoS technology is to maximize the quality of experience (QoE) by satisfying the requirements of each service as much as possible. The mobile communication network may utilize a technique that applies differential traffic policies for individual services in order to provide QoS. The mobile communication network may use the information (IP address, port number) of the service providing servers to infer the type of service and improve QoE by assigning different levels of importance to each service's traffic based on the requirements required for the service. These traffic-specific differential policies can improve QoE in both wired and wireless network segments.

In the case of wired networks, compared to wireless networks, there are more resources available, but traffic may be concentrated in some wired network sections, which can lead to resource shortages. To resolve this situation, techniques such as differentially applying the routing path of traffic or differentially transmitting traffic from the queue of a switch or router are being used.

Compared to wired network resources, wireless resources are very limited and change greatly. In wireless networks. QoS is being achieved through service-specific differential allocation of wireless resources and differential application of wireless communication techniques to efficiently utilize limited wireless resources.

### [Ultra-Low Latency Real-Time Streaming Service]

Streaming services are one of the services with many users next to voice communication. Traditional streaming services have been mostly non-real-time streaming services that play back recorded content regardless of realtimeness. Thereafter, with the advancement of mobile communication technology, the performance (throughput, latency) of mobile communication has also increased, and accordingly, existing streaming services include real-time streaming services that require low latency. In addition to existing non-real-time or real-time streaming services that play content on existing flat displays, beyond 5G (B5G) and 6G mobile communications, which are promising mobile communication technologies to be applied in the future, are expected to provide AR/VR/XR services that are close to the eyes and related to the user's directionality in the form of glasses or lenses. These AR/VR/XR require more traffic processing and traffic transmission capabilities than existing real-time streaming services compared to existing real-time streaming services because they should provide a screen that is equal to or larger than the user's field of view. They also require lower latency compared to existing real-time streaming services.

### [Video Compression: Encoding and Decoding]

The core technology in streaming services is to efficiently transmit the video that constitutes the content from the server to the client. The data size of the video is determined by the composition and quality of the video. If a video is transmitted without applying compression technology, communication resources may be greatly consumed due to the size of the video data. This is an inefficient transmission method for limited communication resources, and the number of service users receiving video data from the same communication resources is bound to be small. Therefore, the provider compresses streaming service video (encoding) and transmits it, and the consumer restores the compressed video (decoding) and plays it. The technology that compresses and restores video in this way is called a codec.

Currently, there are various codecs, but most of the codecs in actual use compress video in units defined as group of pictures (GOP). The GOP is a unit for video playback, and frames, which are scene units of a video, are classified into three types, compressed, and then transmitted. The GOP may be composed of I, P and B frames.

The I-frame is a frame that may be encoded and decoded independently and is the most important frame among the three types of frames.

The P-frame is a frame that may be encoded and decoded by referencing a specific previous frame. The P-frame is a frame encoded by including only the parts that are different from the previous frame, without including the same scene section as the previous frame, so the P-frame cannot be decoded if there is no previous reference frame. The reference frame of a P-frame may be an initial I-frame or a previous P-frame depending on the codec settings.

The B-frame may be encoded and decoded by using two reference frames. The B-frame is a frame that stores a scene that has differences by referencing a previous I-frame or P-frame and a subsequent I-frame or P-frame, and is the least important among the three types of frames.

### [Encoding Reference Option]

The encoding method of the encoder may be set in various ways. In particular, the reference frame of a P-frame may be set in the encoder, and in this disclosure, there are encoding option 1 and encoding option 2 depending on the method of setting the reference frame.

Encoding option 1 is the default option in the codec, and the reference frame of the P-frame is set to the closest P-frame or I-frame among the previous frames. Encoding option 1 is advantageous in terms of P-frame compression ratio, but if reception of even one of the previous P-frames fails, decoding of the remaining P/B-frames may be not possible.

Encoding option 2 is a method that fixes the reference frame of the P-frame to the initial I-frame of the GOP. In this option, there is a disadvantage in terms of compression ratio, but it is efficient in cases where transmission failure of some packets occurs due to the communication environment, and where the realtimeness of packets is frequently invalidated due to packet delay time.

Meanwhile, when applying differential QoS at the base station, the scheduler applies differential scheduling to packets according to their priorities to improve QoE. However, even if differential scheduling is applied, packets stored in the L2 transmission buffer (or, RLC transmission buffer) of the transmitting device (base station or UE) are designed to be transmitted to the receiving device (UE or base station). However, in the case of an ultra-low latency real-time streaming service, even if packets are stored in the L2 transmission buffer, there may be a packet that has lost realtimeness due to a situation of the wireless environment or the wired environment before entering the wireless environment. Even in this case, in the related-art technology, such a packet is transmitted using wireless resources. However, since it is a packet that has lost realtimeness, the application at the receiving end that receives the packet does not play back the frame included in the received packet and drops it. In this case, waste occurs from the perspective of wireless resources because packets that will not be used are transmitted using wireless resources, and from the perspective of time, waste occurs as much as the time consumed for wireless transmission. This waste cannot be solved by a combination of existing technologies alone due to the limitation that the base station does not know the packet and frame related information.

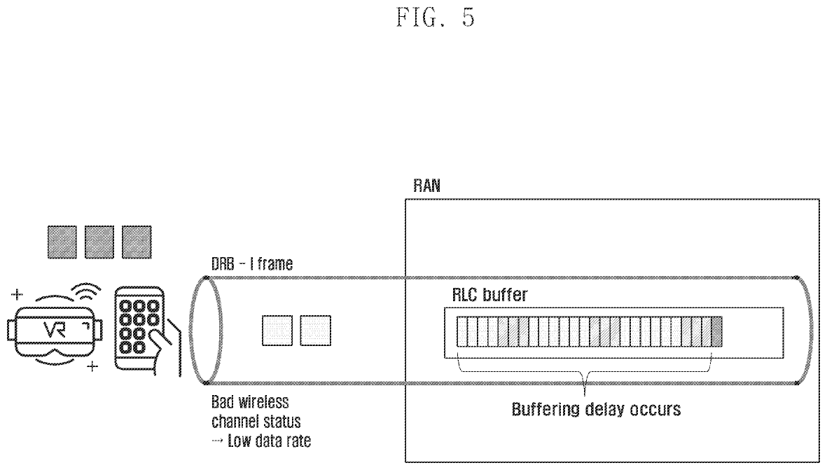

FIG. 5 is a diagram illustrating a problem when a single data radio bearer (DRB) is used according to the disclosure.

The video is transmitted in GOP units, and FIG. 5 is a diagram illustrating a case where it is assumed that the GOP is transmitted in the form of IBBPBBPBBP.

In a good wireless environment, packets will be transmitted without being piled up in the RLC buffer, but if the wireless environment temporarily deteriorates, the transmittable capacity temporarily decreases, so that not all packets are transmitted and some packets are buffered in the RLC buffer. In this case, for existing streaming services or real-time streaming services, the consumer's video playback time is earlier than the actual video production time of the producer, and as a result, the frames buffered in the consumer's application are played first, so the consumer may play back the video without interruption, without experiencing a degradation of the wireless environment. However, in the case of ultra-real-time streaming services, since the producer's video production time and the consumer's video playback time are almost the same, some of the packets buffered in the RLC buffer have already lost realtimeness due to the deterioration of the wireless environment and become unplayable packets. Additionally, additional delay occurs as much as the time consumed by being buffered in the buffer, so the consumer experiences delays and interruptions in video playback as much as the buffering delay.

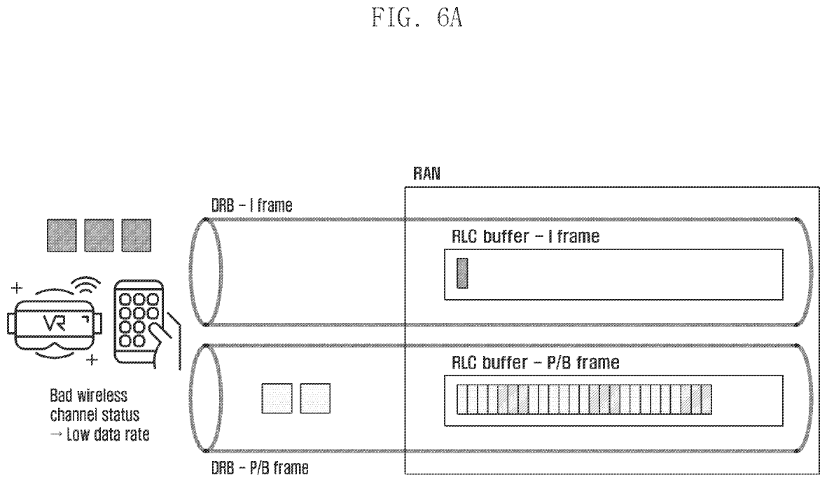

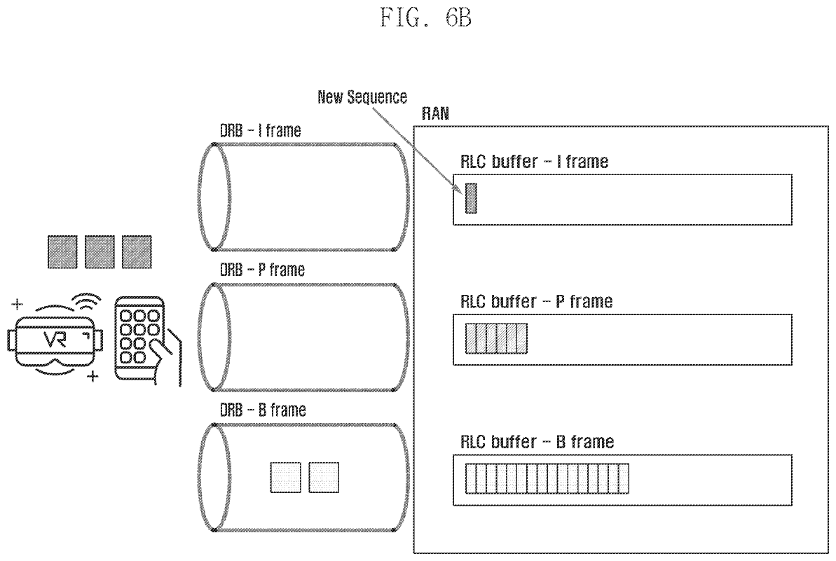

FIG. 6A is a diagram illustrating a method of using two or three DRBs to address delayed video playback according to the disclosure.

With reference to FIG. 6A, this is an embodiment in which the DRB for I-frames and the DRB for P/B-frames are separately generated, while other environment settings including the GOP are the same. Also, it is assumed that the DRB for I-frames has a higher priority than the DRB for P/B-frames. In this case, even if the wireless environment becomes poor and packets are stored in the RLC buffer, since I-frames are stored in the RLC buffer of another DRB and the I-frame related packets are scheduled first by the scheduler, the receiving device may receive I-frames first and play back the video with relatively less interruption. However, if packets of the DRB for P/B-frames, which have lost realtimeness, are transmitted even after the I-frame transmission is complete, a waste occurs in radio resources and time.

With reference to FIG. 6B, this is an embodiment in which the DRB for I-frames, the DRB for P-frames and the DRB for B-frames are separately generated, while other environment settings including the GOP are the same. Also, it is assumed that the DRB for I-frames has a higher priority than the DRB for P-frames and the DRB for B-frames. In this case, even if the wireless environment becomes poor and packets are stored in the RLC buffer, since I-frames are stored in the RLC buffer of another DRB and the I-frame related packets are scheduled first by the scheduler, the receiving device may receive I-frames first and play back the video with relatively less interruption. However, if packets of the DRBs for P-frames and B-frames, which have lost realtimeness, are transmitted even after the I-frame transmission is complete, a waste occurs in radio resources and time. Therefore, a method for efficiently managing the buffer for packets that have lost realtimeness is required, and a method for managing the RLC buffer is disclosed below. Specifically, the disclosure proposes a method for dropping packets including a frame that is not valid in realtimeness among buffered packets. Meanwhile, the expression “dropping a packet” used in the disclosure may be replaced with an expression “deleting a packet” or “discarding a packet”.

<Option 1—Packet Management in RLC Buffer with Reference to the Time Point of the Packet Including Received I-Frame>

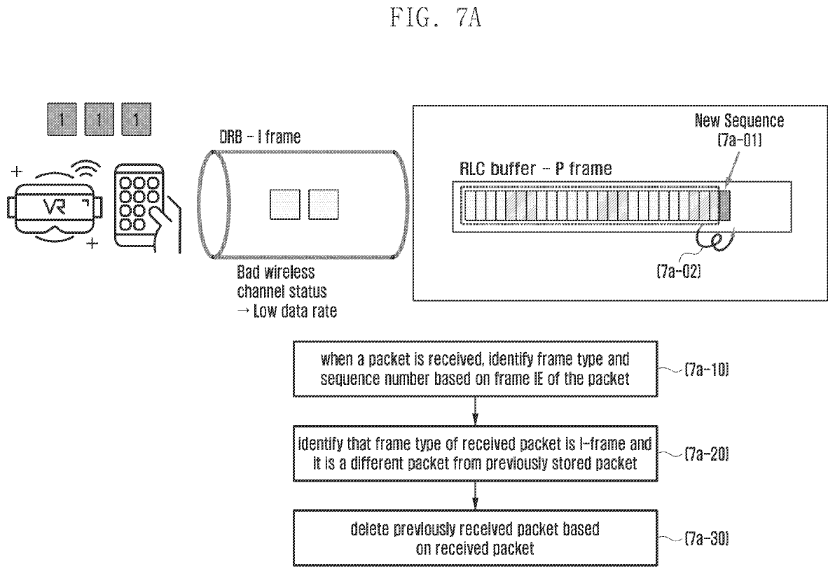

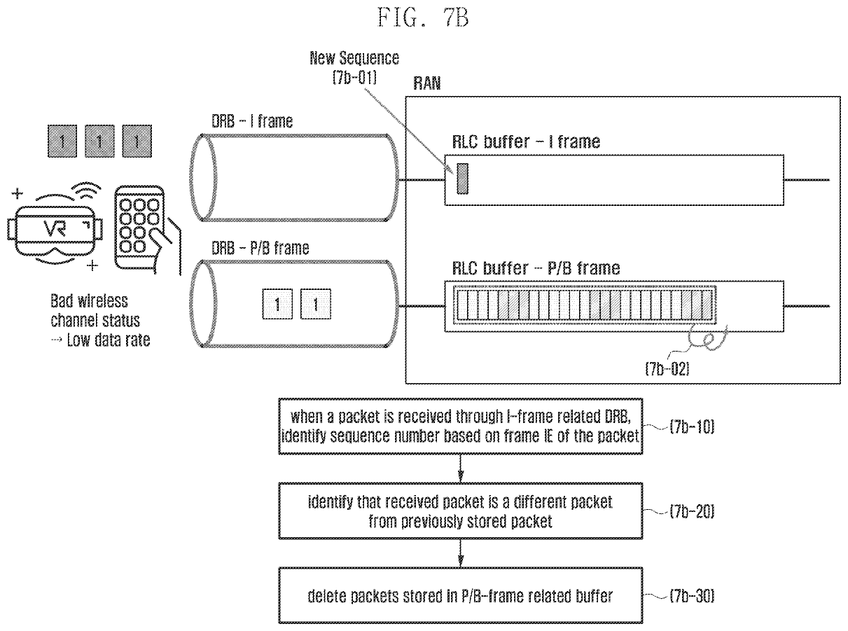

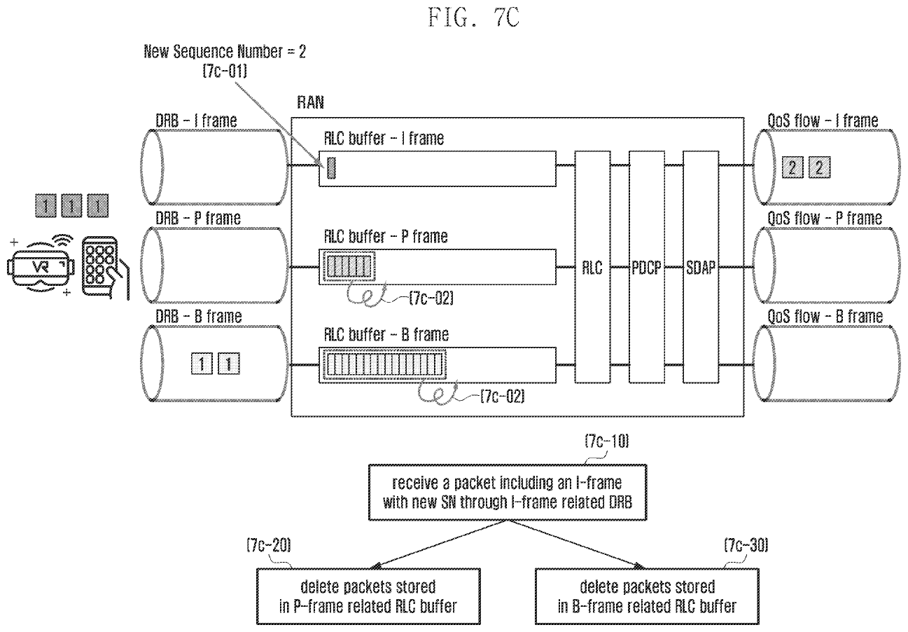

Next, FIGS. 7A to 7C illustrate an embodiment of a method for dropping a packet when a packet including an I-frame having a new frame sequence number is received by the transmitting device without checking the realtimeness of packets in the RLC buffer in a case where single or multiple DRBs are set. Here, the operation of receiving a packet including an I-frame with a new frame sequence number by the transmitting device may be changed to an operation of storing the packet in the RLC buffer of the transmitting device. Additionally, in the following description, the case where the transmitting device receives a packet may mean the case where the RLC layer of the transmitting device receives a packet from another layer.

FIG. 7A illustrates an embodiment of managing packets in a single DRB for ultra-low latency service according to an embodiment of the disclosure.

With reference to FIG. 7A, when a packet including an I-frame with a new frame sequence is stored in the RLC buffer (or, when a packet including a new I-frame is received), the transmitting device may drop all packets that have been stored earlier than the corresponding packet.

Specifically, when a packet is received (7a-01), the transmitting device may identify the frame type and the sequence number of the packet based on the frame information (e.g., frame IE) of the packet (7a-10).

In addition, the transmitting device may identify that the frame type of the received packet is I-frame and that it is a different packet from the previously stored packet (i.e., a packet with a new sequence number, or a packet with a sequence number different from that of the previously stored packet) (7a-20). Meanwhile, steps 7a-10 and 7a-20 may be expressed as one step in which the transmitting device receives a new packet related to I-frame.

Hence, the transmitting device may delete all packets (7a-02) that have been stored in the buffer earlier than the received packet (7a-30).

FIG. 7B illustrates an embodiment of managing packets when dual DRBs are set for ultra-low latency service according to an embodiment of the disclosure.

With reference to FIG. 7B, when a packet including an I-frame with a new frame sequence number is received through the I-frame related DRB, the transmitting device may drop packets stored in the RLC buffer of the P/B-frame related DRB.

Specifically, when a packet is received through the I-frame related DRB (7b-01), the transmitting device may identify the sequence number of the packet (7b-10).

In addition, the transmitting device may identify that the received packet is a different packet from the previously stored packet (i.e., a packet with a new sequence number, or a packet with a sequence number different from that of the previously stored packet) (7b-20). Meanwhile, steps 7b-10 and 7b-20 may be expressed as one step in which the transmitting device receives a new packet through the I-frame related DRB.

Hence, the transmitting device may delete all packets (7b-02) that have been stored in the P/B-frame related buffer earlier than the received packet (7b-30).

FIG. 7C illustrates an embodiment of managing packets when triple DRBs are set for ultra-low latency service according to an embodiment of the disclosure.

With reference to FIG. 7C, when a packet including an I-frame with a new frame sequence number is received through the I-frame related DRB, the transmitting device may drop all P-frames and B-frames that have been stored before the corresponding packet from their RLC buffers.

Specifically, the transmitting device may receive a packet (7c-01) through the I-frame related DRB (7c-10) and may identify the sequence number of the packet.

In addition, if the received packet is a different packet from the previously stored packet, the transmitting device may delete all packets that have been stored in the P-frame related buffer earlier than the received packet (7c-20). Further, the transmitting device may delete all packets (7c-02) that have been stored in the B-frame related buffer earlier than the received packet (7c-20).

<Option 2—Dropping a Packet Including a Received I-Frame being Invalid in Realtimeness>

The present embodiment provides a method of deleting packets being invalid in realtimeness among the buffered packets. Specifically, the transmitting device may calculate the number of packets for which realtimeness is valid, and delete the remaining packets except for the calculated number of packets. Here, the disclosure provides a method for determining the number of packets for which realtimeness is valid based on at least one of the frames per second (FPS) among encoding parameters in the streaming server or the packet delay budget (PDB) value set as a requirement of the corresponding service in the mobile communication network.

### (Encoding Reference Option 1 Case)

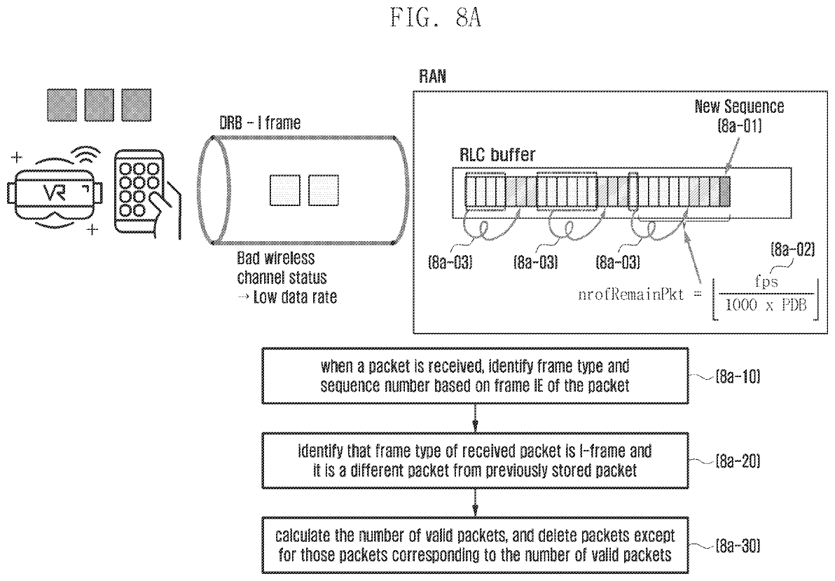

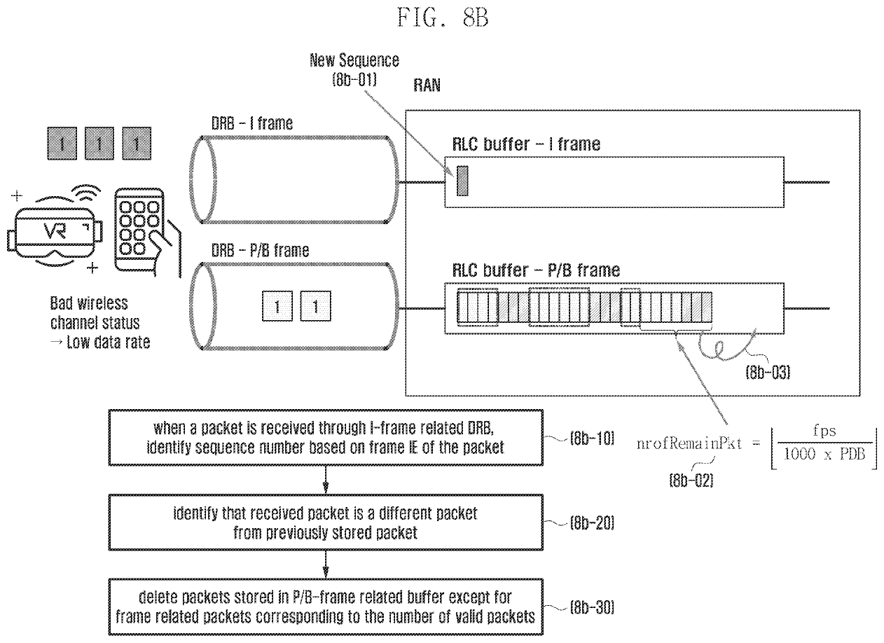

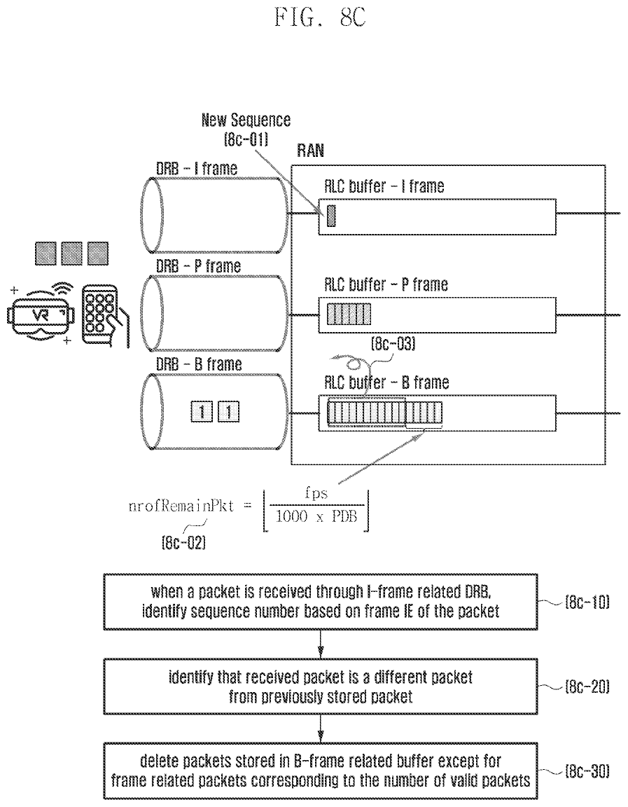

FIGS. 8A to 8C are embodiments in which packets that are not valid in realtimeness are dropped from the RLC buffer when a packet including an I-frame with a new frame sequence number is received by the transmitting device (specifically, RLC layer of the transmitting device) in cases where single or multiple DRBs are set. Here, receiving a packet including an I-frame with a new frame sequence number by the transmitting device may be changed to storing the packet in the RLC buffer of the transmitting device.

FIG. 8A illustrates an embodiment of managing packets when a single DRB is set for ultra-low latency service according to an embodiment of the disclosure.

With reference to FIG. 8A, when a packet including an I-frame with a new frame sequence is stored in the RLC buffer (or, when a packet including a new I-frame is received), the transmitting device may drop a packet including a B-frame for which realtimeness is not valid.

In the case of encoding option 1, if a P-frame is dropped, the P/B-frame following the dropped packet cannot be decoded, so a method of dropping only the B-frame is proposed. However, embodiments of the disclosure are not limited thereto, and an embodiment in which both P-frames and B-frames are dropped may also be considered for encoding option 1.

When a packet is received (8a-01), the transmitting device may identify the frame type and sequence number of the packet based on the frame information (e.g., frame IE) of the packet (8a-10).

In addition, the transmitting device may identify that the frame type of the received packet is I-frame and that it is a different packet from a previously stored packet (i.e., a packet with a new sequence number, or a packet with a sequence number different from that of a previously stored packet) (8a-20). Meanwhile, steps 8a-10 and 8a-20 may be expressed as one step in which the transmitting device receives a new I-frame related packet.

Then, the transmitting device may calculate the number of valid packets and delete packets (8a-03) stored in the buffer except for the packets corresponding to the number of valid packets from the most recently received (or stored) packet (8a-30). As described above, the packets deleted by the transmitting device may be B-frame related packets. Here, the transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 8 a - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

FIG. 8B illustrates an embodiment of managing packets when dual DRBs are set for ultra-low latency service according to an embodiment of the disclosure.

With reference to FIG. 8B, when a packet including an I-frame with a new frame sequence number is received through the I-frame related DRB, the transmitting device may drop a B-frame related packet that is not valid in realtimeness among the packets stored in the P/B-frame related buffer.

Specifically, when a packet is received through the I-frame related DRB (8b-01), the transmitting device may identify the sequence number of the packet (8b-10).

Additionally, the transmitting device may identify that the received packet is a different packet from a previously stored packet (i.e., a packet with a new sequence number, or a packet with a sequence number different from that of a previously stored packet) (8b-20). Meanwhile, steps 8b-10 and 8b-20 may be expressed as one step in which the transmitting device receives a new packet through the I-frame related DRB.

Then, the transmitting device may calculate the number of valid packets and delete packets (8b-03) stored in the P/B-frame related buffer except for the packets corresponding to the number of valid packets from the most recently received (or stored) packet (8b-30). As described above, the packets deleted by the transmitting device may be B-frame related packets. Here, the transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 8 b - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

FIG. 8C illustrates an embodiment of managing packets when triple DRBs are set for ultra-low latency service according to an embodiment of the disclosure.

With reference to FIG. 8C, when a packet including an I-frame with a new frame sequence number is received through the I-frame related DRB, the transmitting device may drop a B-frame related packet that is not valid in realtimeness among the packets stored in the B-frame related buffer.

Specifically, when a packet is received through the I-frame related DRB (8c-01), the transmitting device may identify the sequence number of the packet (8c-10).

Additionally, the transmitting device may identify that the received packet is a different packet from a previously stored packet (i.e., a packet with a new sequence number, or a packet with a sequence number different from that of a previously stored packet) (8c-20). Meanwhile, steps 8c-10 and 8c-20 may be expressed as one step in which the transmitting device receives a new packet through the I-frame related DRB.

Then, the transmitting device may calculate the number of valid packets and delete packets (8c-03) stored in the B-frame related buffer except for the packets corresponding to the number of valid packets from the most recently received (or stored) packet (8c-30). Here, the transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 8 c - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

### (Encoding Reference Option 2 Case)

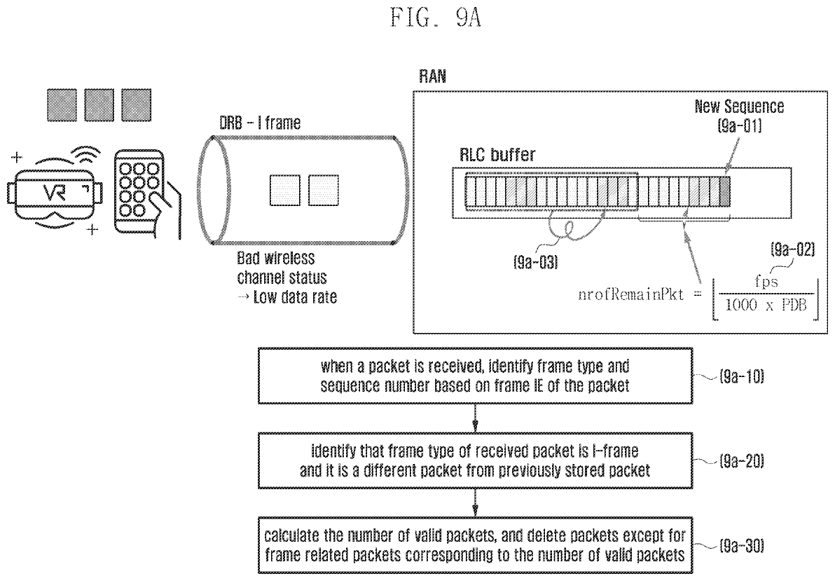

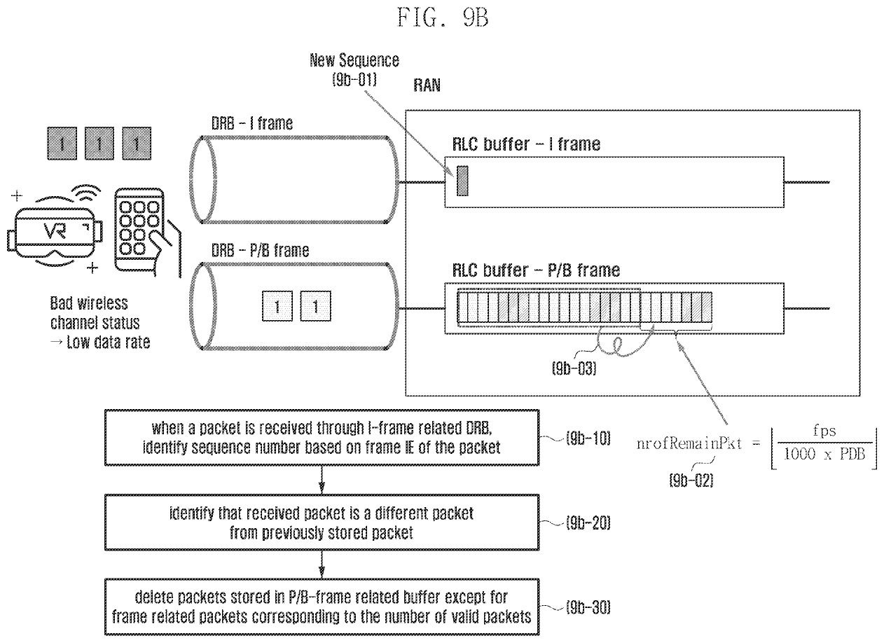

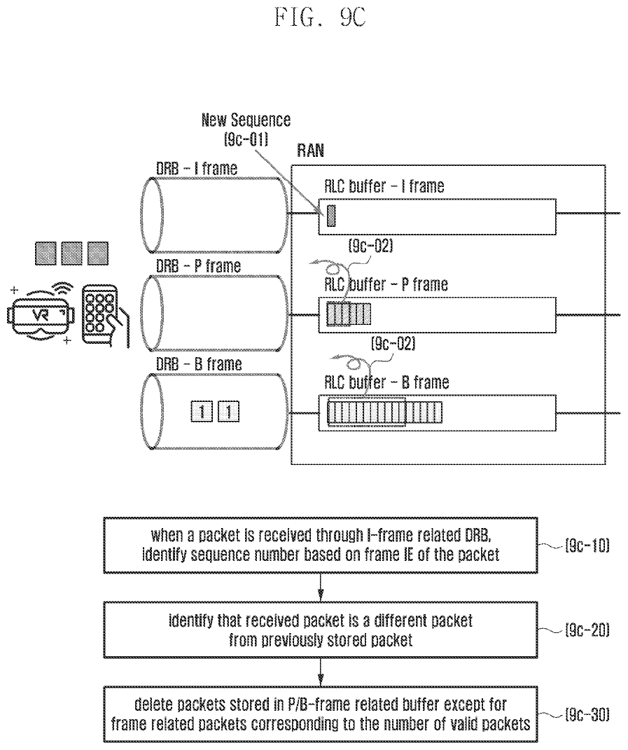

FIGS. 9A and 9B are embodiments in which packets that are not valid in realtimeness are dropped from the RLC buffer when a packet including an I-frame with a new frame sequence number is received by the transmitting device (specifically, RLC layer of the transmitting device) in cases where single or dual DRBs are set. Here, receiving a packet including an I-frame with a new frame sequence number by the transmitting device may be changed to storing the packet in the RLC buffer of the transmitting device.

FIG. 9A illustrates an embodiment of managing packets when a single DRB is set for ultra-low latency service according to an embodiment of the disclosure.

With reference to FIG. 9A, when a packet including an I-frame with a new frame sequence is stored in the RLC buffer (or, when a packet including a new I-frame is received), the transmitting device may drop a packet including a P/B-frame for which realtimeness is not valid.

In the case of encoding option 2, even if a P-frame is dropped, it does not affect the decoding of another P-frame, so both P- and B-frames are dropped. The second drawing also describes a scheme of dropping P/B-frames based on the same criteria. However, the embodiments of the disclosure are not limited thereto, and an embodiment in which only B-frames are dropped may also be considered for encoding option 2.

When a packet is received (9a-01), the transmitting device may identify the frame type and sequence number of the packet based on the frame information (e.g., frame IE) of the packet (9a-10).

In addition, the transmitting device may identify that the frame type of the received packet is I-frame and that it is a different packet from a previously stored packet (i.e., a packet with a new sequence number, or a packet with a sequence number different from that of a previously stored packet) (9a-20). Meanwhile, steps 9a-10 and 9a-20 may be expressed as one step in which the transmitting device receives a new I-frame related packet.

Then, the transmitting device may calculate the number of valid packets and delete packets (9a-03) stored in the buffer except for the packets corresponding to the number of valid packets from the most recently received (or stored) packet (9a-30). As described above, the packets deleted by the transmitting device may be P- and B-frame related packets. Here, the transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 9 a - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

FIG. 9B illustrates an embodiment of managing packets when dual DRBs are set for ultra-low latency service according to an embodiment of the disclosure.

With reference to FIG. 9B, when a packet including an I-frame with a new frame sequence number is received through the I-frame related DRB, the transmitting device may drop a P- or B-frame related packet that is not valid in realtimeness among the packets stored in the P/B-frame related buffer.

Specifically, when a packet is received through the I-frame related DRB (9b41), the transmitting device may identify the sequence number of the packet (9b-10).

Additionally, the transmitting device may identify that the received packet is a different packet from a previously stored packet (i.e., a packet with a new sequence number, or a packet with a sequence number different from that of a previously stored packet) (9b-20). Meanwhile, steps 9b-10 and 9b-20 may be expressed as one step in which the transmitting device receives a new packet through the I-frame related DRB.

Then, the transmitting device may calculate the number of valid packets and delete packets (9b-03) stored in the P/B-frame related buffer except for the packets corresponding to the number of valid packets from the most recently received (or stored) packet (9b-30). As described above, the packets deleted by the transmitting device may be P- or B-frame related packets. Here, the transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 9 b - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

FIG. 9C illustrates an embodiment of managing packets when triple DRBs are set for ultra-low latency service according to an embodiment of the disclosure.

With reference to FIG. 9C, when a packet including an I-frame with a new frame sequence number is received through the I-frame related DRB, the transmitting device may drop a P/B-frame related packet that is not valid in realtimeness among the packets stored in the P/B-frame related buffer.

Specifically, when a packet is received through the I-frame related DRB (9c-01), the transmitting device may identify the sequence number of the packet (9c-10).

Additionally, the transmitting device may identify that the received packet is a different packet from a previously stored packet (i.e., a packet with a new sequence number, or a packet with a sequence number different from that of a previously stored packet) (9c-20). Meanwhile, steps 9c-10 and 9c-20 may be expressed as one step in which the transmitting device receives a new packet through the I-frame related DRB.

Then, the transmitting device may calculate the number of valid packets and delete packets (9c-02) stored in the P/B-frame related buffer except for the packets corresponding to the number of valid packets from the most recently received (or stored) packet (9c-30). Here, the transmitting device may use at least one of the PDB value or the FPS value to determine the number of valid packets. For example, the transmitting device may calculate the number of valid packets based on

$$⌊ \frac{fps}{1000 \times PDB} ⌋ .$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

Meanwhile, in this embodiment, since the P-frame buffer and the B-frame buffer are distinguished, the packet to be deleted from each buffer may be identified in consideration of the GOP pattern. For example, if the GOP pattern is IBBPBBPBBP and the number of valid packets is 5, the transmitting device may repeat the process of marking the packet corresponding to the last P-frame in the P-frame buffer and marking the packet corresponding to the B-frame preceding the P-frame in the B-frame buffer. The transmitting device may repeat the above process to mark 5 packets, and then drop unmarked packets. However, although the present embodiment includes a marking operation to identify valid packets, it should be noted that this is not an operation that is necessarily performed. That is, the transmitting device may determine the number of valid P-frame related packets and B-frame related packets based on the GOP pattern and the number of valid packets, and may delete packets other than the valid number of packets from the P-frame buffer and the B-frame buffer.

<Option 3—Drop Packets Except for Packets that are Valid in Realtimeness as to Received I-Frame Packet and are Decodable>

This embodiment proposes a method of additionally dropping packets that are undecodable due to the encoding characteristics of the GOP in the above-mentioned option 2 embodiment. Through option 3, packets that satisfy realtimeness and are decodable may remain in the RLC buffer, and thus the buffer may be managed efficiently. This embodiment may only be applicable to encoding reference option 2.

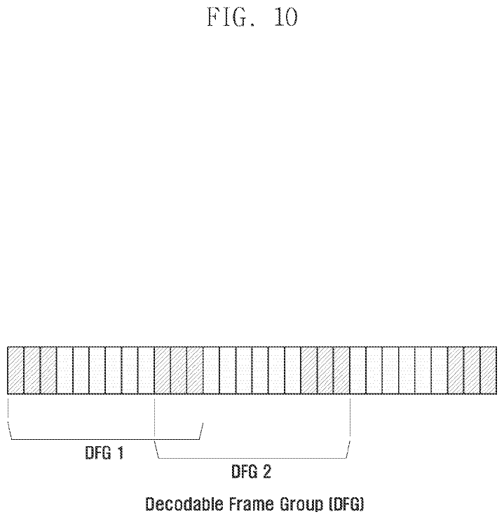

FIG. 10 is a diagram illustrating a decodable frame group (DFG), which is a unit that can be decoded, according to an embodiment of the disclosure.

The DFG is applied in encoding reference option 2, and since the DFG includes all reference frames of a frame, packets and frames of the DFG may be decoded. Here, that is, the DFG may refer to a unit of frames that are decodable. For example, if the GOP is IBBBPBBBPBBBPBP, the DFG may be I or IBBBP or PBBBP or PBP.

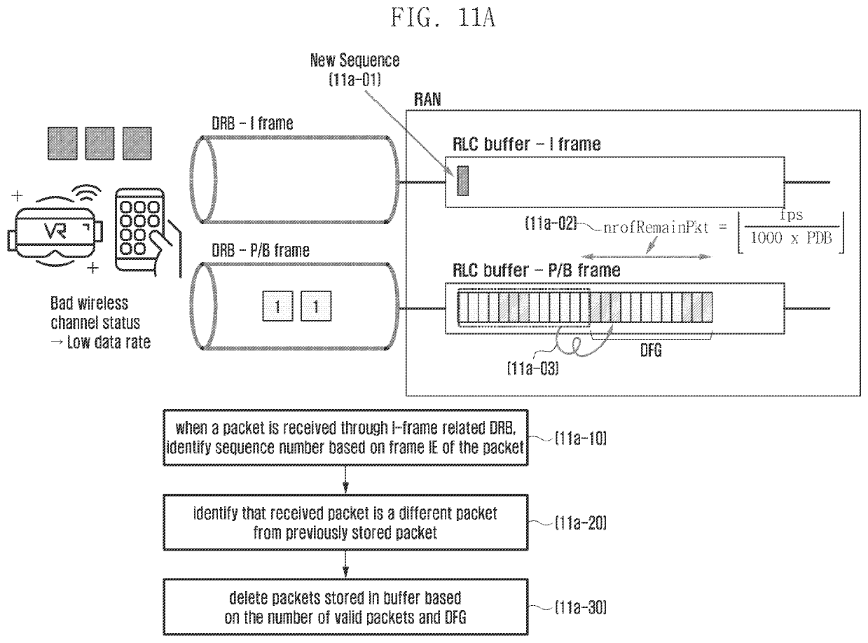

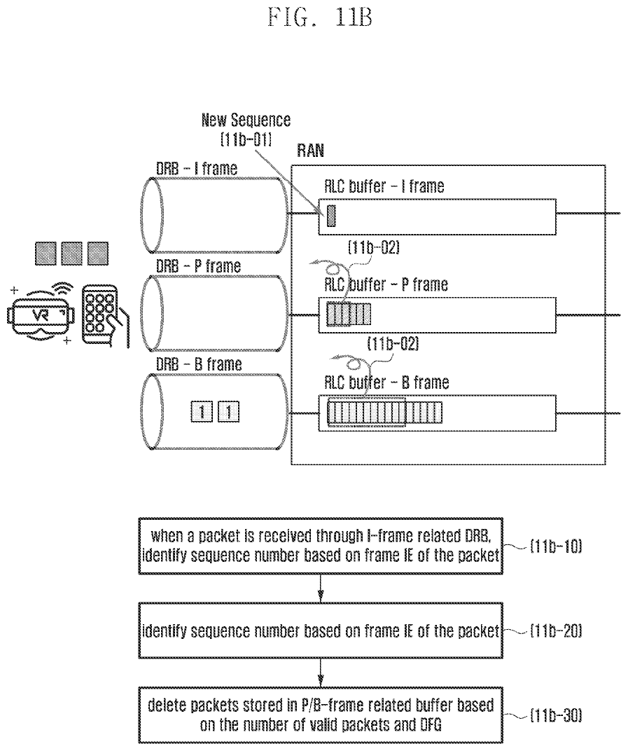

FIG. 11A is a diagram illustrating a method of managing packets based on the DFG according to an embodiment of the disclosure.

With reference to FIG. 11A, a method is proposed of additionally dropping packets that are not included in the DFG after dropping remaining packets except for the packets for which realtimeness is valid as described in option 2.

With reference to FIG. 11A, when a packet including an I-frame with a new frame sequence number is received through the I-frame related DRB, the transmitting device may drop P/B-frame related packets that are not valid in realtimeness among the packets stored in the P/B-frame related buffer and packets that are not included in the DFG among the packets that are valid in realtimeness.

Specifically, when a packet is received through the I-frame related DRB (11a-01), the transmitting device may identify the sequence number of the packet (11a-10). Meanwhile, in this drawing, a case where the I-frame related DRB and the P/B frame related DRB are set separately is described, but the embodiment of the disclosure may be applied equally even when one DRB is set. When one DRB is set, as described above, the transmitting device may perform a step of identifying the frame type based on the frame information and identifying that the frame type of the received packet is I-frame.

The transmitting device may identify that the received packet is a different packet from a previously stored packet (i.e., a packet with a new sequence number, or a packet with a sequence number different from that of a previously stored packet) (11a-20). Meanwhile, steps 11a-10 and 11a-20 may be expressed as one step in which the transmitting device receives a new packet through the I-frame related DRB.

Then, the transmitting device may drop packets from the buffer based on the number of valid packets that have realtimeness (or, will not be dropped) and the DFG (11a-30).

The transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 11 a - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

Additionally, the transmitting device may delete packets (11a-03) stored in the P/B-frame related buffer except for the packets corresponding to the number of valid packets from the most recently received (or stored) packet and packets not included in the DFG. In this way, it is possible to prevent time delay and to efficiently manage the buffer by deleting packets that do not have realtimeness and packets that cannot be decoded.

FIG. 11B is a diagram illustrating a method of managing packets based on the DFG when triple DRBs are set according to an embodiment of the disclosure.

With reference to FIG. 11B, a method is proposed of additionally dropping packets that are not included in the DFG after dropping remaining packets except for the packets for which realtimeness is valid as described in option 2.

With reference to FIG. 11B, when a packet including an I-frame with a new frame sequence number is received through the I-frame related DRB, the transmitting device may drop P/B-frame related packets that are not valid in realtimeness among the packets stored in the P/B-frame related buffer and packets that are not included in the DFG among the packets that are valid in realtimeness.

Specifically, when a packet is received through the I-frame related DRB (11b-01), the transmitting device may identify the sequence number of the packet (11b-10).

The transmitting device may identify that the received packet is a different packet from a previously stored packet (i.e., a packet with a new sequence number, or a packet with a sequence number different from that of a previously stored packet) (11b-20). Meanwhile, steps 11b-10 and 11b-20 may be expressed as one step in which the transmitting device receives a new packet through the I-frame related DRB.

Then, the transmitting device may drop packets from the buffer based on the number of valid packets that have realtimeness (or, will not be dropped) and the DFG (11b-30).

The transmitting device may use at least one of the PDB value or the FPS value to determine the number of valid packets. For example, the transmitting device may calculate the number of valid packets based on

$$⌊ \frac{fps}{1000 \times PDB} ⌋ . \qquad ( 11 b - 02 )$$

However, this equation is only one embodiment of the disclosure, and various methods of determining the number of packets with realtimeness by utilizing the PDB may be applied in the disclosure. Meanwhile, the FPS value may be configured by the base station to the UE, and the specific method will be described later.

Then, the transmitter may determine packets to be left in the B-frame related buffer and P-frame related buffer in consideration of the GOP pattern and the DFG, and delete remaining packets except for these packets. Specifically, the transmitting device may identify packets corresponding to the number of valid packets by considering the GOP pattern from the most recently received (or stored) packet, and delete packets (11b-02) stored in the P-frame related buffer and the B-frame related buffer and packets not included in the DFG. For example, if the GOP pattern is IBBBPBBBPBBBPBP and the number of valid packets is 8, the transmitting device may repeat a process of marking the packet corresponding to the last P-frame in the P-frame buffer and marking the packet corresponding to the B-frame preceding the P-frame in the B-frame buffer. Here, the transmitting device may mark 7 packets except for the B-frame packet, which is a packet not included in the DFG among the 8 packets, and then drop the unmarked packets (since the number of valid packets is 8, after being separated into IBBBPBB/BPBBBPBP, the first part should be deleted, and the first B-frame in the second part should also be deleted because it is not included in the DFG). However, although this embodiment includes a marking operation to identify valid packets, it should be noted that this is not an operation that is necessarily performed. That is, the transmitting device may identify the number of valid P-frame related packets and B-frame related packets based on the GOP pattern and the number of valid packets, and may delete the remaining packets from the P-frame buffer and the B-frame buffer except for the packets corresponding to the number of valid packets. In this embodiment, since the number of valid P-frame related packets is 3 and the number of valid B-frame related packets is 4, the transmitting device may delete packets except for those 3 packets from the P-frame buffer and delete packets except for those 4 packets from the B-frame buffer.

### [Reordering Skipping Technique in RLC and PDCP]

In this disclosure, packets that are not valid in realtimeness or packets that are not valid in realtimeness and cannot be decoded are dropped from the RLC buffer. However, in the related art, there is no consideration for intentional packet drops in the RLC buffer. Hence, in the related art, if some packets are dropped, it may be regarded as a temporary deterioration of the wireless channel environment or as an unintentional cause due to other reasons, and retransmission may be performed. As a result, even if the transmitting device drops packets according to the disclosure, the receiving device may regard it as an unintentional packet drop and continuously request retransmission, which may cause a phenomenon in which communication becomes impossible. Accordingly, the disclosure proposes a method for the transmitting device to notify the receiving device (RLC layer and PDCP layer) that it has dropped some packets from the RLC buffer.

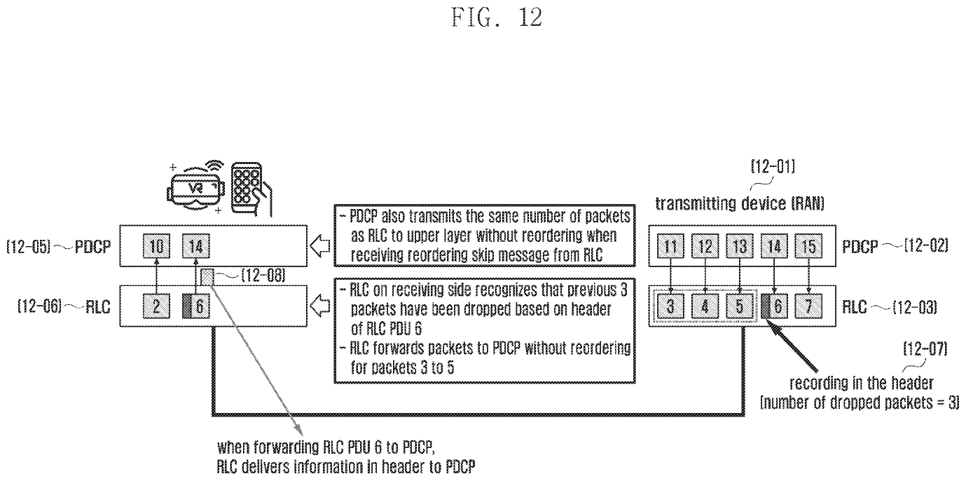

FIG. 12 is a diagram illustrating a method for the transmitting device to inform the receiving device of packet drop related information according to an embodiment of the disclosure.

With reference to FIG. 12, an embodiment is illustrated in which the RLC sequence number of a dropped packet is notified by the transmitting device (e.g., RAN) 1201 to the receiving device (e.g., UE or VR/XR glass) 1202, and the RLC layer 1206 of the receiving device notifies the packet drop information to the PDCP layer 1205. Meanwhile, the disclosure describes a case where the transmitting device is the RAN and the receiving device is a UE, but embodiments of the disclosure may be applied even when the transmitting device is a UE.

First, there is a PDCP sequence number for each packet in the PDCP layer, and there is an RLC sequence number for each packet in the RLC layer. These two sequence numbers are separate numbers. FIG. 12 illustrates a case where the RLC layer 1203 of the transmitting device 1201 intentionally drops RLC sequence numbers 3, 4 and 5 from the RLC buffer. In this case, if the receiving device does not know this drop, it may request retransmission and wait for reordering until packets 3, 4 and 5 are received. Accordingly, in this embodiment, to inform the receiving device that a packet has been dropped from the RLC buffer, information indicating that a packet has been dropped (packet drop information, packet deletion information) may be included in the header 1207 of the RLC PDU. Here, the header of the RLC PDU may include information about the number of dropped packets, and in this embodiment, since packets 3, 4 and 5 are dropped, the corresponding information may be set to 3. The way of setting the above information specifically will be described later.

Thereafter, when packet 6 is received after reception of packet 2 in the RLC layer 1206 and the dropped packet information in the RLC header of packet 6 is set to 3, the receiving device may recognize that packets 3, 4 and 5 have been dropped by the transmitting device. Hence, the receiving device does not request retransmission and may forward packets 2 and 6 to the PDCP layer 1205 without performing reordering. Here, the RLC layer may transfer the corresponding RLC PDU of packet 6 to the PDCP layer, where the packet drop information (or, packet deletion information) may be forwarded to the PDCP. So, even if packet 14 is received after receiving packet 10, the PDCP layer may forward the packets to the upper layer without performing reordering.

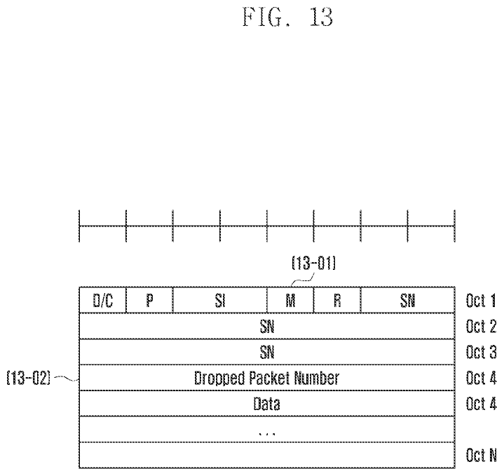

FIG. 13 is a diagram illustrating a header format according to an embodiment of the disclosure.

When dropping a packet, the transmitting device may transmit packet drop information (or, packet deletion information) by including it in the AMD PDU header (header in AM mode) of the RLC PDU.

In this case, the above information may include a 1-bit M field 13-01 indicating that some packets before the packet including this header have been dropped, and a Dropped Packet Number field 13-02 indicating the number of dropped packets. That is, if the M field is indicated as 0, the Dropped Packet Number field is not included in the PDU header, and if the M field is indicated as 1, the Dropped Packet Number field may be included in the PDU header. Alternatively, the M field may be not present in the PDU header, and the PDU header may be set to always include Dropped Packet Number. Additionally, the packet drop information (or, packet deletion information) of the disclosure may be a term referring to the Dropped Packet Number field, or referring to the Dropped Packet Number field and the M field.

In the receiving device, the RLC layer receives packet 6 without receiving packets 3, 4 and 5, and if the M field in the PDU header of packet 6 is set to 1, it may recognize that some packets before packet 6 have been dropped by the transmitting device. Additionally, the receiving device may check the value (e.g., 3) of the Dropped Packet Number field of the PDU header (in the drawing, it is written in 8 bits, but the number of bits of this field may change depending on the maximum number of dropped packets), and be aware that packets 3, 4 and 5 have been dropped by the transmitting device. Hence, the receiving device may temporarily disable the reordering function of the RLC layer and forward packet 6 to the PDCP layer. In addition, since the PDCP layer also has a reordering function, the RLC layer may forward the information in the RLC header to the PDCP layer, so that the PDCP layer can also skip the reordering function for the corresponding packets.

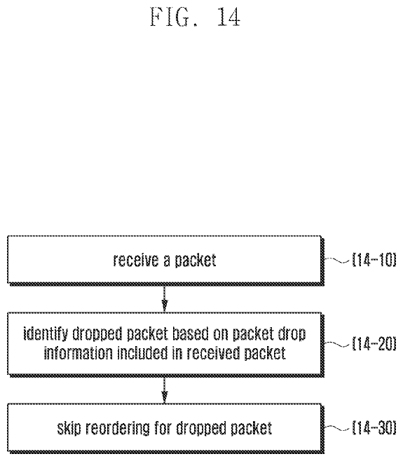

FIG. 14 is a diagram illustrating a flowchart of the receiving device in the case of packet drop according to an embodiment of the disclosure.

With reference to FIG. 14, the receiving device may receive a packet from the transmitting device (14-10). The receiving device may check the packet deletion information included in the received packet. The packet deletion information is identical to that described in FIG. 13, and a description thereof is omitted below.

Thereafter, the receiving device may identify the packets dropped or deleted by the transmitting device based on the packet deletion information (14-20). Specifically, the receiving device may determine whether an unreceived packet has been deleted based on the sequence number of the previously received packet, the sequence number of the packet received at step 14-10, and the number of deleted packets indicated by the packet deletion information.

Then, the receiving device may process the received packet without performing reordering on the deleted packet (14-30). That is, in the receiving device, the RLC layer may forward packets to the PDCP layer without performing reordering, and the PDCP layer may forward packets to an upper layer without performing reordering.

Meanwhile, the receiving device may perform step 14-30 according to the outOfOrderSkip field included in an RRC message. That is, if the outOfOrderSkip field is set to True or the RRC message includes the outOfOrderSkip field, the receiving device may perform step 1430 above. Additionally, if the outOfOrderSkip field is not set to True (or, is set to False) or the RRC message does not include the outOfOrderSkip field, the receiving device may not perform step 1430 above.

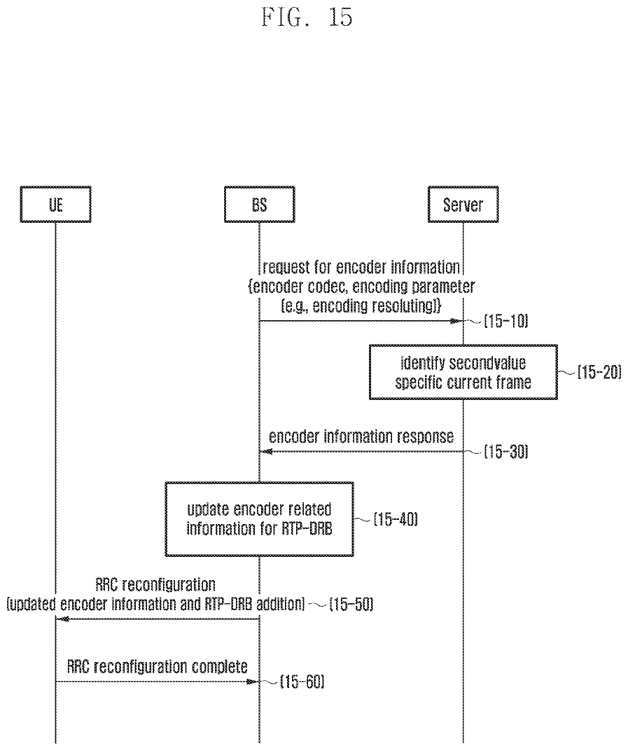

FIG. 15 illustrates a sequence diagram for configuring DRBs for ultra-real-time streaming service according to an embodiment of the disclosure.

Meanwhile, the disclosure utilizes the PDB and FPS to determine whether a packet is valid in realtimeness. The PDB is a preset value within the network, but the FPS may be set differently depending on the encoding server. The FPS value may be inferred through codec information in the RTP (real time transport protocol) header, but more accurate information may be obtained through information exchange with the server. Hence, the disclosure proposes a method that enables the UE to obtain encoding-related information before generating a DRB for ultra-low latency real-time streaming.

The base station makes a request for encoder information to the streaming server (15-10). Here, the encoder information may include information about at least one of encoder codec or encoding parameters (e.g., FPS, encoding option, resolution, quantization parameter) of the server.

The server may check the encoder information (15-20). In this disclosure, the server may check the current FPS value according to the encoder information request. Then, the server may transmit the encoder information to the base station (15-30).

Thereafter, the base station having received the encoder information may update the encoder information (15-40). However, if the base station does not have encoder information, this update step may be skipped.

Then, the base station may transmit an RRC reconfiguration message to the UE (15-50). A DRB may be generated based on the DRB configuration information included in the RRC message. Additionally, if the DRB configuration information includes information indicating a DRB for ultra-low latency real-time streaming (hereinafter, RTP-DRB), the DRB may be used as a DRB for ultra-low latency real-time streaming. Further, the RRC reconfiguration message may include the encoder information. The above DRB may be configured or released through an RRC reconfiguration message.

Specifically, the DRB configuration information may be composed as shown in Table 1 below.

TABLE 1
RadioBearerConfig

| | |
|---|---|
| -- ASN1START | |
| -- TAG-RADIOBEARERCONFIG-START | |
| RadioBearerConfig :: [symbol] | SEQUENCE { |
| srb-ToAddModList | SRB-ToAddModList |
| OPTIONAL, -- Cond HO-Conn | |
| srb3-ToRelease | ENUMERATED{true} |
| OPTIONAL, -- Need N | |
| drb-ToAddModList | DRB-ToAddModList |
| OPTIONAL, -- Cond HO-toNR | |
| drb-ToReleaseList | DRB-ToReleaseList |
| OPTIONAL, -- Need N | |
| securityConfig | SecurityConfig |
| OPTIONAL, -- Need M | |
| ..., | |
| [[ | |
| mrb-ToAddModList-r17 | MRB-ToAddModList-r17 |
| OPTIONAL, -- Need N | |
| mrb-ToReleaseList-r17 | MRB-ToReleaseList-r17 |
| OPTIONAL, -- Need N | |
| srb [symbol] -ToAddMod-r17 | SRB-ToAddMod |
| OPTIONAL, -- Need N | |
| srb [symbol] -ToAddMod-r17 | ENUMERATED{true} |
| OPTIONAL, -- Need N | |
| ]] | |
| } | |
| [symbol] | |
| DRB-ToAddModList ::= [symbol] | SEQUENCE (SIZE (1..maxDRB)) OF D [symbol] -ToAddMod |
| DRB-ToAddMod :: [symbol] | SEQUENCE { |
| [symbol] nAssociation | CHOICE { |
| eps-BearerIdentity | INTEGER {0..15 [symbol] , |
| sdap-Config | SDAP-Config |
| } | |
| OPTIONAL, -- Cond DRBSetup | |
| drb-Identity | DRB-Identity, |
| reestablishPDCP | ENUMERATED{true} |
| OPTIONAL, -- Need N | |
| recoverPDCP | ENUMERATED{true} |
| OPTIONAL, -- Need N | |
| pdcp-Config | PDCP-Config |
| OPTIONAL, -- Cond PDCP | |
| rtp-Config | ENUMERATED{true} |
| OPTIONAL, -- Cond RTP | |
| videoCodec | VideoCodec |
| OPTIONAL, -- Cond RTP | |
| framePerSecond | FramePerSecond |
| OPTIONAL, -- Cond RTP | |
| encodingOption | EncodingOption |
| OPTIONAL -- Cond RTP | |
| ..., | |
| [[ | |
| daps-Config-r16 | ENUMERATED{true} |
| OPTIONAL -- Cond DAPS | |
| ]] | |
| } | |

VideoCodec ::= EXAMERATED (H.262, H.263, H.265, H.265, [symbol] , [symbol] 2)
FramePerSecond ::= ENUMERATED (10, 15, 20, 25, 30, 35, 40, 45, 50, 55, 60, 65, 70, 75,

80, 85, 90, 95, 100, 105, 310, 115, 120)

EncodingOption ::= ENUMERATED (1, 2, spare1, spare2, spare3)

}
}
-- TAG-RADIOBEARERCONFIG-STOP
-- ASN1STOP

[symbol]

indicates data missing or illegible when filed

With reference to Table 1, a DRB may be configured based on the DRB-ToAddMod field (DRB configuration information), and the DRB configuration information may include rtp-Config, which is information indicating whether the DRB is an RTP-DRB.

In addition, if the DRB is configured as RTP-DRB (rtp-Config is set to True, or rtp-Config is included in the DRB configuration information), encoder information to be used for the DRB may be further included. For example, at least one of VideoCodec information, FPS information, or encoding option information may be included. Here, in Table 1, the FPS is described as being set to any one of 10, 15, 20, 25, 30, 35, 40, 45, 50, 55, 60, 65, 70, 75, 80, 85, 90, 95, 100, 105, 110, 115 and 120, but the candidates for the FPS value may be set in various ways.

Meanwhile, PDCP configuration information (pdcp-Config) included in the DRB configuration information may be composed as shown in Table 2 below.

TABLE 2
PDCP-Config

```
-- ASN1START
-- TAG-PDCP-CONFIG-START
PDCP-Config ::= SEQUENCE {
  drb SEQUENCE {
    discardTimer ENUMERATED {mx10, ms20, ms30, ms40, mx50, ms60, ms75, ms100,
ms150, ms200,
                                          ms250, ms300, ms500, ms750, ms1500, infinity)
OPTIONAL, -- Cond Setup
    pdcp-SN-SizeUL ENUMERATED {len12bits, len18bits}
OPTIONAL, -- Cond Setup1
    pdcp-SN-SizeDL ENUMERATED {len12bits, len18bits}
OPTIONAL, -- Cond Setup2
    headerCompression   CHOICE {
      notUsed NULL,
      ro [symbol] c   SEQUENCE {
        maxCID INTEGER (1..16383)
DEFAULT 15,
          profiles SEQUENCE {
            profile0x0001 BOOLEAN,
            profile0x0002 BOOLEAN,
            profile0x0003 BOOLEAN,
            profile0x0004 BOOLEAN,
            profile0x0006 BOOLEAN,
            profile0x0101 BOOLEAN,
            profile0x0102 BOOLEAN,
            profile0x0103 BOOLEAN,
            profile0x0104 BOOLEAN
          },
          drb-ContinueROHC ENUMERATED { true }
OPTIONAL   -- Need N
      },
      uplinkOnlyROHC SEQUENCE {
          maxCID INTEGER (1..16383)
DEFAULT 15,
          profiles SEQUENCE {
            profile0x0006 BOOLEAN
          },
          drb-ContinueROHC ENUMERATED { true }
OPTIONAL -- Need N
      },
      ...
    },
    integrityProtection ENUMERATED { enabled }
OPTIONAL, -- Cond ConnectedToSOC1
    statusReportRequired ENUMERATED { true }
OPTIONAL, -- Cond [symbol] -AM-UM
    outOfOrderDelivery ENUMERATED { true }
OPTIONAL, -- Need R
    outOfOrderSkip ENUMERATED { true } OPTIONAL, -- Need R
  }
  ...
OPTIONAL, -- Cond DRB
-- TAG-PDCP-CONFIG-STOP
-- ASN1STOP [symbol]
indicates data missing or illegible when filed
```

As described above, for RTP-DRB, the PDCP layer of the receiving device may forward packets to the upper layer without performing reordering for the packet dropped by the transmitting device, and for this purpose, the base station may transmit, to the UE, the PDCP configuration information including outOfOderSkip (information indicating skipping reordering for the packet dropped by the transmitting device). Then, if outOfOderSkip of the PDCP configuration information is set to True (or, if outOfOderSkip is included in the PDCP configuration information), the PDCP layer of the receiving device may skip reordering for the packets dropped by the transmitting device. However, the above information structure is only one embodiment of the disclosure, and a case where the outOfOrderSkip field is not used may be considered. That is, if the DRB is an RTP-DRB, reordering may always be skipped if there is a packet dropped by the transmitting device among the packets received through the RTP-DRB.

Additionally. RLC configuration information (RLC-config) may be composed as shown in Table 3 below.

TABLE 3
RLC-Config

| | |
|---|---|
| RLC-Config ::= | CHOICE { |
| am | SEQUENCE { |
| ul-AM-RLC | UL-AM-RLC, |
| dl-AM-RLC | DL-AM-RLC |
| }, | |
| um-Bi-Directional | SEQUENCE { |
| ul-UM-RLC | UL-UM-RLC, |
| dl-UM-RLC | DL-UM-RLC |
| }, | |
| um-Uni-Directional-UL | SEQUENCE { |
| ul-UM-RLC | UL-UM-RLC |
| }, | |
| um-Uni-Directional-DL | SEQUENCE { |
| dl-UM-RLC | DL-UM-RLC |
| }, | |
| ... | |
| } | |
| UL-AM-RLC ::= | SEQUENCE { |
| sn-FieldLength | SN-FieldLengthAM |
| OPTIONAL, -- Cond Reestab | |
| t-PollRetransmit | T-PollRetransmit, |
| pollPDU | PollPDU, |
| pollByte | PollByte, |
| maxRetxThreshold | ENUMERATED { t1, t2, t3, t4, t6, t8, t16, t32 } |
| rtpBufferManagement | ENUMERATED { true } OPTIONAL -- Need R |
| outOfOrderSkip | ENUMERATED { true } OPTIONAL, -- Need R |
| } | |
| DL-AM-RLC :: [symbol] | SEQUENCE { |
| sn-FieldLength | SN-FieldLengthAM |
| OPTIONAL, -- Cond Reestab | |
| t-Reassembly | T-Reassembly, |
| t-StatusProhibit | T-StatusProhibit |
| [symbol] pBufferManagement | ENUMERATED { true } OPTIONAL -- Need R |
| outOfOrderSkip | ENUMERATED { true } OPTIONAL, -- Need R |
| } | |
| ... | |
| -- [symbol] - [symbol] -CONFIG-STOP | |
| -- [symbol] STOP | |

[symbol]

indicates data missing or illegible when filed

As described above, for RTP-DRB, the RLC layer of the receiving device may forward packets to the upper layer without performing reordering for the packet dropped by the transmitting device, and for this purpose, the base station may transmit, to the UE, the RLC configuration information including outOfOderSkip (information indicating skipping reordering for the packet dropped by the transmitting device). Then, if outOfOderSkip of the RLC configuration information is set to True (or, if outOfOderSkip is included in the RLC configuration information), the RLC layer of the receiving device may skip reordering for the packets dropped by the transmitting device.

Further, for RTP-DRB, the RLC layer of the transmitting device may drop a packet for which realtimeness is not valid, and the base station may transmit, to the UE, RLC configuration information including rtpBufferManagement (information indicating dropping packets for which realtimeness is not valid). Then, if rtpBufferManagement in the RLC configuration information is set to True (or, if rtpBufferManagement is included in the RLC configuration information), the receiving device may recognize that the transmitting device is configured to perform packet dropping.

However, the above information structure is only one embodiment of the disclosure, and a case where the outOfOrderSkip field and rtpBufferManagement are not used may be considered. That is, if the DRB is an RTP-DRB, and if there is a packet dropped by the transmitting device among the packets received through the RTP-DRB, reordering may always be skipped, and packets for which realtimeness is not valid may be dropped.

When RRC reconfiguration is completed, the UE may transmit an RRC reconfiguration complete message to the base station (1460). Thereby, the UE may receive ultra-low latency real-time streaming packets through the RTP-DRB, and decode these packets based on the encoder information. In addition, according to the above-described method, when a new I-frame related packet is received in the RLC layer or stored in the RLC buffer, the base station may delete (drop) previously stored P/B-frame related packets (or B-frame related packets), delete (drop) packets that are not valid in realtimeness, or delete (drop) packets that are not valid in realtimeness and are not included in the DFG. Here, the base station may utilize the FPS value included in the encoder information described above to identify a packet that is valid in realtimeness. However, if the encoder information does not include FPS information, the base station may assume the FPS to be the maximum configurable fps based on the codec information of the RTP header, or to be the fps most frequently set when the ultra-low latency real-time streaming service is used.

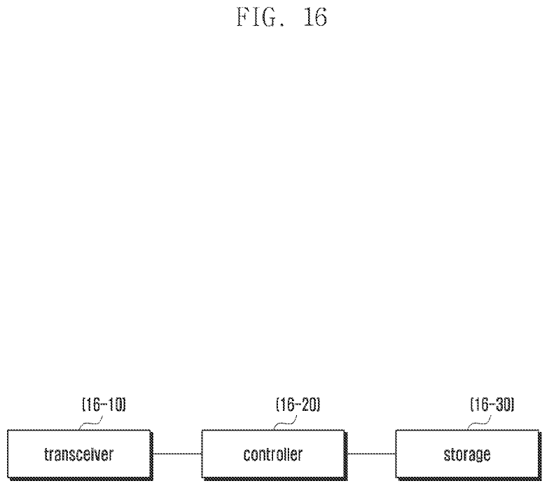

FIG. 16 is a diagram illustrating the structure of a transmitting device according to an embodiment of the disclosure.

With reference to FIG. 16, the transmitting device may include a transceiver 16-10, a controller 16-20, and a storage 16-30. In the disclosure, the controller may be referred to as a circuit, an application-specific integrated circuit, or at least one processor.

The transceiver 16-10 may transmit and receive signals to and from other entities. The transceiver 16-10 may receive data from, for example, the network or other device, and may transmit generated data to another device.

The controller 16-20 may control the overall operation of the transmitting device according to the embodiment proposed in the disclosure. For example, the controller 16-20 may control the signal flow between blocks to perform the operation according to the above-described flowchart. For example, the controller 16-20 may receive an I-frame related packet having a different sequence number from the packets stored in the buffer, determine the number of valid packets based on the FPS (frames per second) value, and delete packets stored in the buffer except for packets corresponding to the number of valid packets. In addition, the controller 16-20 may control the operation proposed in the disclosure.

The storage 16-30 may store at least one of the information transmitted and received through the transceiver 16-10 or the information generated through the controller 16-20.

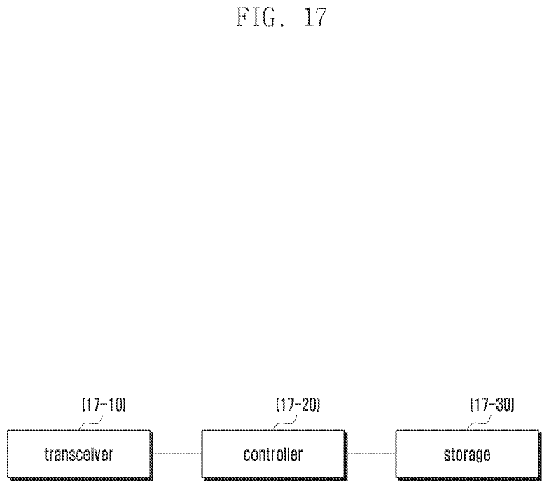

FIG. 17 is a diagram illustrating the structure of a receiving device according to an embodiment of the disclosure.

With reference to FIG. 17, the receiving device may include a transceiver 17-10, a controller 17-20, and a storage 17-30. In the disclosure, the controller may be referred to as a circuit, an application-specific integrated circuit, or at least one processor.

The transceiver 17-10 may transmit and receive signals to and from other entities. The transceiver 17-10 may receive data from, for example, the network or other device, and may transmit generated data to another device.

The controller 17-20 may control the overall operation of the receiving device according to the embodiment proposed in the disclosure. For example, the controller 17-20 may control the signal flow between blocks to perform the operation according to the above-described flowchart. For example, the controller 17-20 may receive a packet from the transmitting device according to an embodiment of the disclosure, identify a packet deleted by the transmitting device based on packet deletion information included in the received packet, and process the received packet without performing reordering on the deleted packet. In addition, the controller 17-20 may control the operation proposed in the disclosure.

The storage 17-30 may store at least one of the information transmitted and received through the transceiver 17-10 or the information generated through the controller 17-20.

Meanwhile, the order of description in the drawings explaining the method of the disclosure does not necessarily correspond to the order of execution, and steps may be changed in the execution order or executed in parallel.

Alternatively, in the drawings illustrating the method of the disclosure, some components may be omitted and only some components may be included without damaging the essence of the disclosure.

In addition, the method of the disclosure may be implemented by combining parts or all of the contents included in individual embodiments within a range that does not damage the essence of the disclosure.

1. A method performed by a transmitting device for an ultra-low latency service in a communication system, the method comprising:
receiving an I-frame related packet having a sequence number different from a sequence of packets stored in a buffer;
identifying a number of valid packets based on a frames-per-second (FPS) value; and
deleting packets stored in the buffer except for packets corresponding to the number of valid packets.

2. The method of claim 1, wherein deleting packets stored in the buffer further comprises deleting packets that are not included in a decodable frame group (DFG) among the packets corresponding to the number of valid packets.

3. The method of claim 1, further comprising transmitting a radio resource control (RRC) reconfiguration message,
wherein the RRC reconfiguration message includes configuration information about a data radio bearer (DRB) for the ultra-low latency service, and
wherein the configuration information includes information about the FPS value.

4. The method of claim 3, wherein in case that the RRC reconfiguration message does not include the FPS value, the FPS value is set to a maximum value that is settable based on configured codec information or to a value that is most frequently set for the ultra-low latency service.

5. The method of claim 1, further comprising transmitting a packet stored in the buffer to a receiving device, and
wherein a header of the transmitted packet includes information indicating a number of deleted packets.

6. A method performed by a receiving device for an ultra-low latency service in a communication system, the method comprising:
receiving, from a transmitting device, a packet;
identifying a packet deleted by the transmitting device based on packet deletion information included in the received packet; and
processing the received packet without reordering for the deleted packet.

7. The method of claim 6, further comprising receiving a radio resource control (RRC) reconfiguration message,
wherein the RRC reconfiguration message includes configuration information about a data radio bearer (DRB) for the ultra-low latency service, and
wherein the configuration information includes information indicating skipping of reordering for the deleted packet.

8. The method of claim 6, wherein the packet deletion information includes information indicating a number of deleted packets.

9. A transmitting device for an ultra-low latency service in a communication system, comprising:
a transceiver; and
a controller coupled with the transceiver and configured to:
receive an I-frame related packet having a sequence number different from a sequence of packets stored in a buffer;
identify a number of valid packets based on a frames-per-second (FPS) value; and
delete packets stored in the buffer except for packets corresponding to the number of valid packets.

10. The transmitting device of claim 9, wherein the controller is configured to delete packets that are not included in a decodable frame group (DFG) among the packets corresponding to the number of valid packets.

11. The transmitting device of claim 10, wherein:
the controller is configured to transmit a radio resource control (RRC) reconfiguration message;
the RRC reconfiguration message includes configuration information about a data radio bearer (DRB) for the ultra-low latency service; and
the configuration information includes information about the FPS value.

12. The transmitting device of claim 11, wherein in case that the RRC reconfiguration message does not include the FPS value, the FPS value is set to a maximum value that is settable based on configured codec information or to a value that is most frequently set for the ultra-low latency service.

13. The transmitting device of claim 10, wherein:
the controller is configured to transmit a packet stored in the buffer to a receiving device; and
a header of the transmitted packet includes information indicating a number of deleted packets.

14. A receiving device for an ultra-low latency service in a communication system, comprising:
a transceiver; and
a controller coupled with the transceiver and configured to:
receive, from a transmitting device, a packet;
identify a packet deleted by the transmitting device based on packet deletion information included in the received packet; and
process the received packet without reordering for the deleted packet.

15. The receiving device of claim 14, wherein:
the controller is configured to receive a radio resource control (RRC) reconfiguration message;
the RRC reconfiguration message includes configuration information about a data radio bearer (DRB) for the ultra-low latency service;
the configuration information includes information indicating skipping of reordering for the deleted packet; and
the packet deletion information includes information indicating a number of deleted packets.
